(19) United States
(12) Patent Application Publication
(10) Pub. No.: US 2026/0212840 A1
(43) Pub. Date: Jul. 23, 2026

(54) Privacy Preserving Gaze for Foveated Rendering

(71) Applicant: Apple Inc., Cupertino, CA (US)

(72) Inventors: Courtland M Idstrom, Cupertino, CA (US); Caitlin M Crawford, San Carlos, CA (US); Jacob Wilson, San Francisco, CA (US)

(21) Appl. No.: 19/449,737

(22) Filed: Jan. 15, 2026

Related U.S. Application Data
(60) Provisional application No. 63/746,610, filed on Jan. 17, 2025.

(51) Int. Cl. G09G 5/391; G02B 27/00; G02B 27/01; G06F 21/62; G06T 7/50

(52) U.S. Cl. CPC G09G 5/391; G02B 27/0093; G02B 27/0172; G06F 21/6245; G06T 7/50; G09G 2340/0407

(57) ABSTRACT

Systems and methods that enable applications to perform local or remote foveated rendering are disclosed. The systems and methods provide applications with eye gaze-based information in a way that preserves user privacy. For example, this may involve providing information that down-samples information about where a user is gazing, e.g., only identifying a point on a fixed-point grid of points corresponding to relatively large display regions within which the user is gazing and/or using or providing approximate depth (e.g., distance from viewpoint information) regarding the portion of the environment at which the user is gazing. The techniques may avoid sharing information about precisely where the user is looking and/or information about user eye conditions (e.g., eye divergence, lazy eye, etc.).

### CROSS-REFERENCE TO RELATED APPLICATIONS

This Application claims the benefit of U.S. Provisional Application Serial No. 63/746,610 filed January 17, 2025, which is incorporated herein in its entirety.

### TECHNICAL FIELD

The present disclosure generally relates to electronic devices that enable applications to perform processes, such as foveated rendering, by providing information about user gaze that is generalized or otherwise obscured to preserve user privacy.

### BACKGROUND

Existing systems may be improved with respect to enabling applications to use gaze and other eye information in ways that preserve private aspects of user information.

### SUMMARY

Various implementations disclosed herein include devices, systems, and methods that enable applications to perform processes, such as local or remote foveated rendering, by providing the applications with eye gaze-based information in a way that preserves user privacy. For example, this may involve providing information that down-samples information about where a user is gazing, e.g., only identifying a point on a fixed-point grid of points corresponding to relatively large display regions within which the user is gazing and/or providing approximate depth (e.g., distance from viewpoint) information regarding the portion of the environment at which the user is gazing. The techniques may avoid sharing information about precisely where the user is looking and/or information about user eye conditions (e.g., eye divergence, lazy eye, etc.). The techniques may, for example, do so by identifying a point/region/direction generally corresponding to a user’s gaze (e.g., a monocular gaze direction-based point that identifies only a general relatively large region of a display at which the user is looking) and/or approximate depth information that identifies only a relatively large depth range of content at which the user is looking.

Using or providing gaze information based on only a single eye may (i.e., rather than information based on both eyes individually) may avoid revealing information about user eye conditions such as a lazy eye condition. Using or providing approximate depth information may enable gaze-based information derived from tracking a single eye to be used to identify approximately which portions of a 3D environment in the user’s view that the user is gazing at, without revealing specifically what the user is looking at. For example, gaze direction information from one eye and depth information may be used to identify a gaze direction from a viewpoint position that is not associated with either eye (e.g., from a viewpoint between the eye positions). Such a direction may be determined and provided to an application. The information may alternatively be provided to the application so that it may determine the gaze direction from such a viewpoint position (e.g., from a center position).

Techniques disclosed herein may provide sufficient gaze information to enable foveated rendering. The system (e.g., an operating system process or other trusted process) may provide sufficient information to enable foveated rendering in circumstances in which such rendering is necessitated by system and/or communication constraints, e.g., circumstances in which an application uses a remote foveated rendering process to encode and transmit dual views in real time, where system or communication constraints would prevent dual 4k processing.

In some implementations, a processor performs a method by executing instructions stored on a computer readable medium. The method involves obtaining a gaze direction corresponding to a gaze of an eye of a user of the electronic device.

The method involves identifying a display region (e.g., a point corresponding to a region of interest) to which the gaze direction corresponds, the display region is identified from amongst a set of multiple display regions (e.g., a grid of display regions) corresponding to at least a portion of a display of the electronic device. Each display region may be associated with point within a respective display region (e.g., a center point within each respective region) that will be used to provide gaze information instead of using the actual gaze direction or location on the display associated therewith. In some implementations, each display region is associated with enter and exit boundaries that differ from one another and that are used to further obscure gaze information, e.g., gaze information may be provided based on enter and exit events associated with those boundaries.

The method involves identifying depth data (e.g., an approximate depth) based on a portion of an environment corresponding to the gaze direction. This may involve determining that the user is gazing at a portion of a display of the device (e.g., a portion of an HMD’s display positioned in front of the user’s eye) and that the content at that portion of the display corresponds to a portion of a 3D extended reality (XR) environment that is (or that the user perceives as being) a distance away from the user.

The method further involves providing generalized gaze information for rendering content of an application, where the generalized gaze information is based on identifying the display region to which the gaze direction corresponds and identifying the depth data. The generalized gaze information may identify that the gaze corresponds to the display region, for example, by identifying the region itself, a fixed point within (e.g., at the center of) the region, a direction from a user viewpoint (e.g., from either eye position or an eye center position) to a fixed point within the region, etc. The generalized gaze information may identify that the gaze corresponds to a depth (e.g., an approximate distance of the content at which the user is gazing from the user’s viewpoint). The content of the application is rendered using a foveated rendering process that uses the generalized gaze information. In one use scenario, the application performs a local rendering process (e.g., on the electronic device) that displays the rendered content on the electronic device. In another use scenario, the application utilized a remote rendering process (e.g., on a device separate from the electronic device) that transmits renderings (e.g., views) to the electronic device for display on the electronic device.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates exemplary an electronic device operating in a physical environment, in accordance with some implementations.

FIG. 2 illustrates an extended reality (XR) environment view provided by the electronic device of FIG. 1, in accordance with some implementations.

FIG. 3 illustrates regions of a display showing the view of FIG. 2, in accordance with some implementations.

FIG. 4 illustrates a foveation area associated with one of the regions of FIG. 3, in accordance with some implementations.

FIG. 5 illustrates an enter boundary and an exit boundary associated with one of the regions of FIG. 3, in accordance with some implementations.

FIG. 6 illustrates use of depth information in providing generalized user gaze information, in accordance with some implementations.

FIG. 7 illustrates use of a single direction based on a binocular gaze assessment to represent a gaze, in accordance with some implementations.

FIG. 8 illustrates use of a single direction based on a monocular gaze assessment to represent a gaze, in accordance with some implementations.

FIG. 9 is a flowchart illustrating a method for enabling application use of gaze information by providing generalized gaze information, in accordance with some implementations.

FIG. 10 is a block diagram of an electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

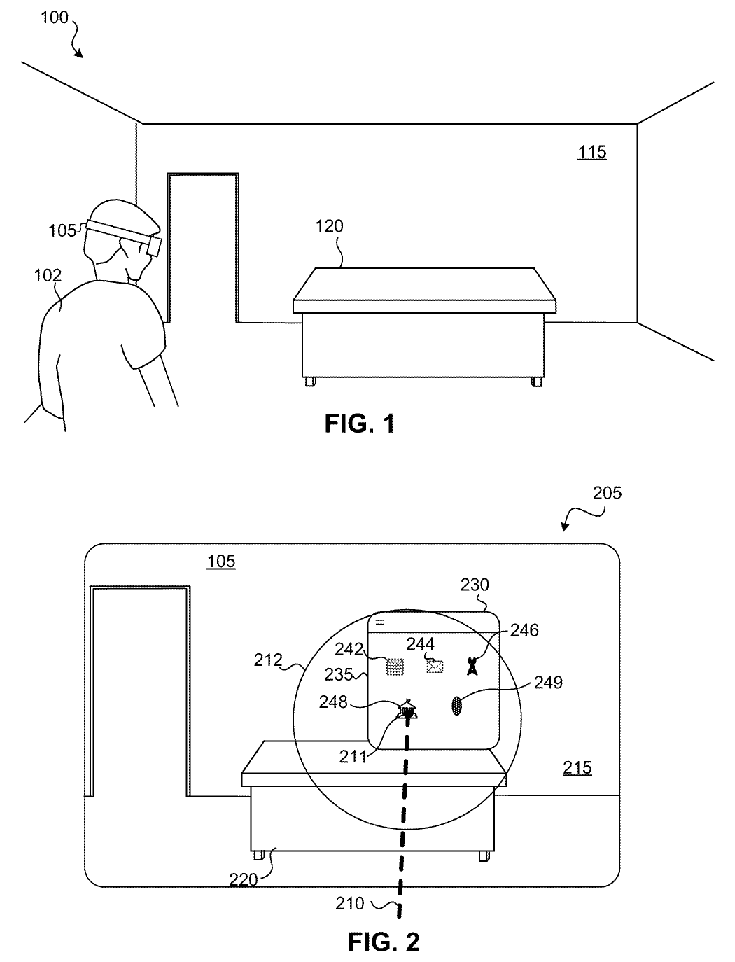

FIG. 1 illustrates an exemplary electronic device operating in a physical environment 100. In the example of FIG. 1, the physical environment 100 is a room that includes a desk 120 and wall 115, among other things not illustrated for simplicity. The electronic device 105 may include one or more cameras, microphones, depth sensors, or other sensors that can be used to capture information about and evaluate the physical environment 100 and the objects within it, as well as information about the user 102 of electronic device 105. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic device 105 (e.g., a wearable device such as an HMD, a handheld device such as a mobile device, a tablet computing device, a laptop computer, etc.). Such an XR environment may include views of a 3D environment (e.g., a virtual environment, the physical environment 100, or combined real and virtual content forming a 3D environment). An XR environment may be generated, at least in part, based on camera images and/or depth camera images of the physical environment 100. Such an XR environment may include virtual content that is positioned at 3D locations relative to a 3D coordinate system (i.e., a 3D space) associated with the XR environment, which may correspond to a 3D coordinate system of the physical environment 100.

In various implementations, an operating system (OS) of the electronic device 105 renders none, some, or all of the XR environment, e.g., providing views of the XR environment from one or more viewpoints over time. In various implementations, an application (e.g., separate from the operating system (OS)) renders none, some, or all of the XR environment. For example, an application may render virtual reality (VR) environment in which an entirety of the view provided by electronic device 105 depicts a view of a 3D virtual world from a viewpoint that corresponds to the pose (e.g., position and/or orientation) electronic device 105.

In some implementations, video (e.g., pass-through video depicting a physical environment) is received from an image sensor of a device (e.g., device 105 or device 110). In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment.

In some implementations, a viewpoint within the 3D coordinate system may be determined based on a position of the electronic device within the physical environment. The viewpoint may be determined based on, inter alia, image data, depth sensor data, motion sensor data, etc., which may be retrieved via a virtual inertial odometry system (VIO), a simultaneous localization and mapping (SLAM) system, etc. The user’s view of the environment may thus change over time based on a viewpoint change that corresponds to the user moving (e.g., moving the electronic device within the physical environment).

FIG. 2 illustrates an XR environment view 205 provided by the electronic device 105. The view 205 of the XR environment include a rendering of an exemplary user interface 230 of an application (i.e., an example of virtual content) and a depiction 220 of the desk 120 and a depiction 215 of wall 115 (i.e., examples of real content). Providing such a view 205 may involve determining 3D attributes of the physical environment 100 and positioning the virtual content, e.g., user interface 230, in a 3D coordinate system corresponding to that physical environment 100. In various examples, an application may render content for display that 2D, 3D, or a combination of 2D and 3D and the application may render none, some, or all of the content that is displayed in the view at various points in time, e.g., during a user experience that lasts a period of time.

In the example of FIG. 2, the user interface 230 includes various user interface elements, including a background portion 235 and icons 242, 244, 246, 248, 249. The icons 242, 244, 246, 248, 249 may be displayed on the flat user interface 230. The user interface 230 may be a user interface of an application, as illustrated in this example. The user interface 230 is simplified for purposes of illustration and user interfaces in practice may include any degree of complexity, any number of content items, and/or combinations of 2D and/or 3D content. The user interface 230 (and other virtual content occupying some or all of the view 205) may be rendered and provided by operating systems and/or applications of various types including, but not limited to, messaging applications, web browser applications, content viewing applications, content creation and editing applications, or any other applications that can display, present, or otherwise use visual and/or audio content. The content rendered in the view may be combination of content rendered via a OS or other trusted processes and content rendered by one or more applications, separate from the OS or other trusted processes.

In the example of FIG. 2, the user is gazing in gaze direction 210 at user interface icon 211. It may be desirable for the operating system (OS) and/or applications being used on the electronic device (or remote processes used thereby) to utilize gaze information, such as the gaze direction 211. For example, gaze information, such as the gaze direction 211, may be used to perform foveated rendering, e.g., identifying foveated rendering boundary 212 based on the gaze direction 211, and rendering content inside and outside of the boundary 211 differently according to known foveated rendering techniques. However, it may be undesirable to make specific gaze information, such as gaze direction 210, known to an application (or remote processes used thereby). Implementations disclosed herein preserve user privacy (i.e., implementing predetermined user privacy criteria) by providing generalized user information instead of specific user information. The generalized user information may be configured to provide information that is sufficiently useful for an application to achieve various functions, e.g., for foveated rendering that is almost as good as, or as good as, the foveated rendering that would be performed using more specific information that would require revealing private information.

Some implementations disclosed herein facilitate off-device rendering. For example, it may be desirable to have off-device resources perform rendering functions. In such a case, system and communication limitations, e.g., bandwidth, processing, etc., may prevent rendering and transmitting a dual (e.g., left and right eye) feed of a particular resolution (e.g., 4K) at a particular frame rate (e.g., 60 fps). The rendering and/or transmitting may be reduced to be within the system limitations, for example, using a foveated rendering technique to reduce the amount of computations and/or the amount of data in the feed. To enable such processes, general gaze information may be provided to the off-device resource(s). However, rather than identifying a specific gaze direction or other information from which the precise content that the user is gazing at may be determined, the system may provide more general information, such as information about a relatively large region of a display at which the user is looking.

The OS may additionally use approximate depth information to determine approximately the portion of the 3D environment at which the user is gazing and provide a generalized direction based on this depth information to the application. Alternatively, the OS may provide a general gaze direction based on a monocular gaze assessment and depth information and the application may itself use this information (monocular gaze and depth) determine the generalized gaze direction relative to 3D content, e.g., 3D content to be rendered using a foveated rendering process that uses that information.

The general information provided to an application may be sufficiently specific to facilitate meaningful foveated rendering without providing specific information about the user’s gaze and/or eye characteristics (e.g., eye divergence, lazy eye, accessibility conditions, etc.).

In some implementations, generalized information is provided without use of eye data, e.g., based on head direction rather than eye direction. For example, the general head direction may be used to predict which of multiple regions of a display the user is focused on, attentive to, etc.

In some implementations, generalized information is provided based on information about monocular gaze direction (e.g., using the gaze direction of the user’s dominant eye).

In some implementations, generalized information is provided based on information about binocular gaze direction (e.g., providing a single direction that is the average of the user’s two gaze directions from a viewpoint between the user’s eyes).

In some implementations, generalized information (e.g., information about a general region upon which a user is focused) is provided to an application (e.g., a game-streaming application) running on a head-mounted device (HMD). The application may itself or via an off-device process perform some processes (e.g., transformations, rendering content, etc.) and provide frame data for display on the HMD. The application processes may utilize focus region information, e.g., generalized gaze-based information that obfuscates the user’s actual gaze direction. The HMD (e.g., its gaze tracking or other operating system processes) may reduce the granularity of the gaze-based information so that the application processes are able to perform their functions (e.g., to improve the quality of 3D content, utilize general gaze information as input, perform foveated rendering, etc.) without receiving or otherwise having access to specific gaze-based information that would be considered private to the user.

The system’s gaze tracking processes may utilize information about what is being displayed by the device. For example, based on understanding what is displayed on a display in front of the user’s left eye and the user’s left eye gaze direction, the system may determine generalized information to provide to an application. For example, this may involve mapping the display’s area into regions (e.g., a grid of relatively large regions) and determining which region the user’s gaze is within and then only providing general information about this region (rather than the specific gaze direction) to the application.

Moreover, the display may display content that depicts or corresponds to a 3D environment (e.g., a 3D XR environment) and the system may determine the depth (i.e., distance away from the viewpoint in the 3D XR environment) of the content at which the user is looking. The depth information may also be obfuscated, e.g., by rounding, averaging, etc. For example, if the user is looking at content between 0 and 3 feet away, a depth value of 1.5 feet may be provided; if the user is looking at content between 3 and 6 feet away, a depth value of 4.5 feet may be provided; if the user is looking at content between 6 and 9 feet away, a depth value of 7.5 feet may be provided, etc. In some implementations, the depth of the content at which the user is looking is determined based on the 3D environment that is displayed. In some implementations, the depth of the content at which the user is looking is determined based on additional or alternative information, for example, based on determining where (e.g., the distance away) the user’s two eye gazes converge. However determined, the depth information may be obfuscated to avoid providing the application with information about the specific depth of the content at which the user is looking and/or information about the user’s eyes, e.g., eye convergence information.

Some implementations, map a user’s gaze direction to a fixed-point grid corresponding to portions of a display. Mapping the user’s gaze direction to the fixed-point grid may enable provision of generalized information about a region of interest to an application (e.g., an application separate from the OS such as an application offered by a 3^{rd} party different than the developer of the OS). It may do so in a way that preserves user privacy (e.g., without exposing raw gaze data, expressing eye divergence, accessibility issues, etc.).

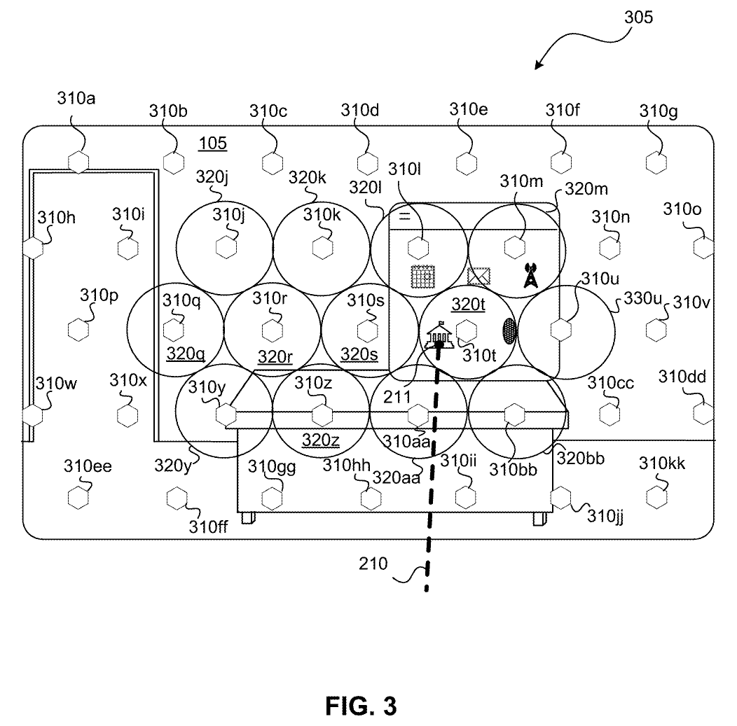

FIG. 3 illustrates regions of a display 305 showing the view of FIG. 2. In this example, a plurality of points 310a-kk on the display 305 are specified at fixed positions on the display 305 (e.g., at fixed pixel positions). Some or all of the plurality of points 310a-kk is associated with a region of the display 305. As examples illustrated in FIG. 3, point 310j is associated with region 320j, point 310k is associated with region 320k, point 310l is associated with region 320l, point 310m is associated with region 320m, point 310q is associated with region 320q, point 310r is associated with region 320r, point 310s is associated with region 320s, point 310t is associated with region 320t, point 310u is associated with region 320u, point 310y is associated with region 320y, point 310z is associated with region 320z, point 310aa is associated with region 320aa, and point 310bb is associated with region 320bb. The regions 320j, 320k, 320l, 320m, 320q, 320r, 320s, 320t, 320u, 320y, 320z, 320aa, 320bb are adjacent to one another and circular in this example. In some implementations, the regions may be configured to have no space between them and/or to collectively occupy all pixels of the display. In some implementations, the regions are triangular, square, pentagons, hexagons, or other geometric shapes. The regions may have different shapes and/or sizes. The regions may represent all of the display’s area. The regions may represent less than all of the display’s area, e.g., only a central region, etc.

In some examples, gaze direction information is down-sampled or otherwise obscured by associating a given detected gaze direction with a corresponding point and/or region of the display. For example, gaze direction 210 is directed to a portion of the display within region 320t and thus may be associated with point 310t and/or region 320t. This down-sampled/obscured gaze information (i.e., identifying point 310t and/or region 320t and/or other information associated therewith) may be provided to an application or an associated process instead of the more granular information about where the user is actually gazing. For example, an operating system (OS) or other trusted device process may identify the gaze direction, determine the associated display point and/or region, and provide information to the application that identifies this display point or region. The recipient application may use this information. The application may recognize from the identification of point 310t or associated region 320t that the user’s gaze is associated with this region 320t (e.g., within this region 320t, within a known distance of this region 320t, entering this region 320t or an area associated with this region 320t, exiting this region 320t or an area associated with this region 320t, etc.).

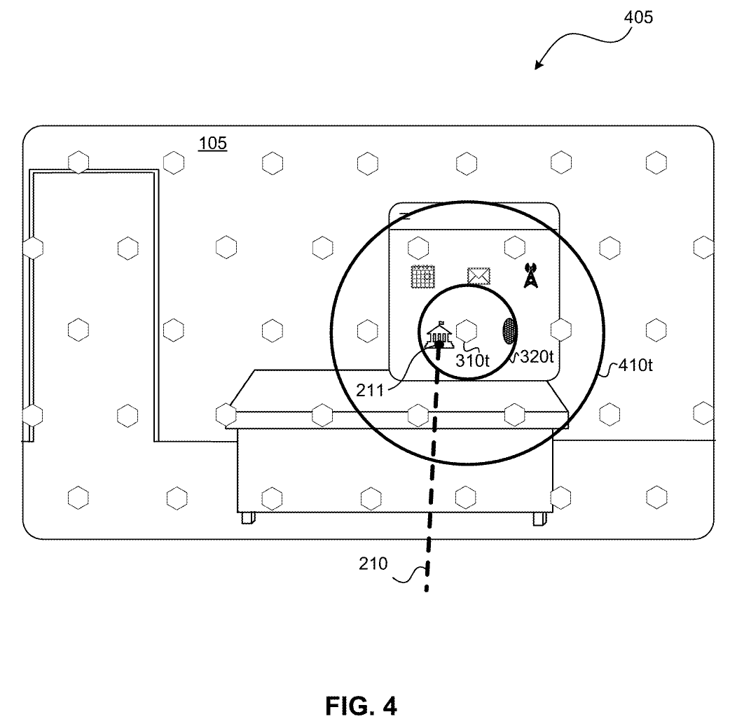

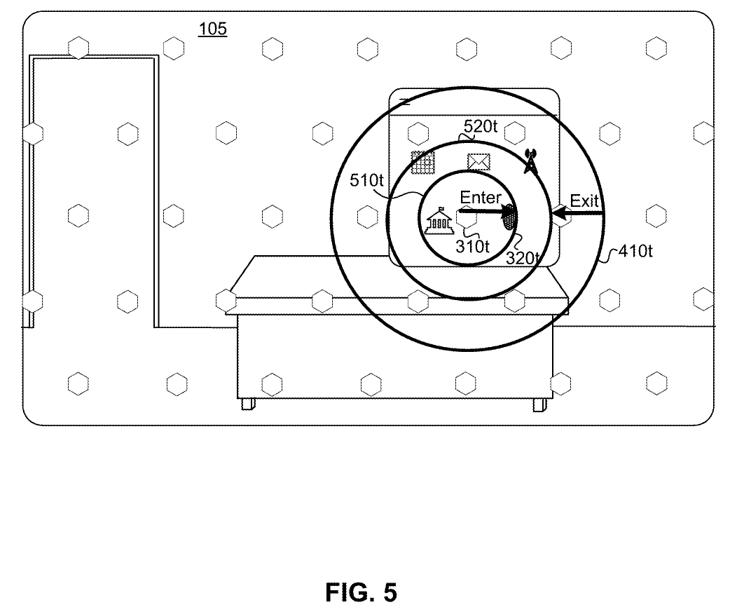

FIG. 4 illustrates a foveation area 410t associated with one of the regions (i.e., region 320t) of FIG. 3. In this example, the foveation area 410t is bigger than the region 320t. The foveation area 410t may be bigger, smaller, or the same size as the region 320t to which it corresponds.

In some implementations, an operating system (OS) or other trusted device process may identify a user’s gaze direction, determine the associated display point and/or region, determine a foveation area (e.g., foveation area 410t) based on the point or region, and provide information to the application that identifies this foveation area. The recipient application may use this information to provide foveated rendering of content and/or for other purposes.

In some implementations, an operating system (OS) or other trusted device process may identify a user’s gaze direction, determine the associated display point and/or region, and provide information to the application that identifies this display point and/or region. The recipient application may use this information about the display point and/or region to determine a foveation area (e.g., foveation area 410t) and use this foveation area to provide foveated rendering of content and/or for other purposes.

The information about a point (e.g., point 310t), corresponding region (e.g., region 320t), and/or corresponding foveation area (e.g., foveation area 410t) may be obscured based on parameters that ensure one or more privacy criteria. A gaze direction used for the basis of data provided to an application may be obscured to at least a threshold level. The information may be configured to never reveal (directly or indirectly) a user’s gaze direction within a predetermined number of degrees (e.g., 5 degrees, 10 degrees, etc.).

In some implementations, data about a user’s gaze is provided to an application (or processes used thereby) over time in ways that further obscure the user’s gaze and eye information. Such information may be provided sporadically, e.g., only upon the occurrence of certain events such as user actions (e.g., clicks, pinches, etc.) and/or in certain circumstances (e.g., when the user’s gaze enters or leaves the multiple regions into which the display space is divided). In some implementations, one or more boundaries are used, and the provision of gaze information is limited to occurring only when the user’s gaze crosses such boundaries. In some implementations such boundaries are associated the user’s gaze entering a first area associated with a point on the display and/or the user’s gaze leaving a second are associated with the point on the display. These areas may overlap or have boundaries that overlap partially, entirely or not at all. These areas may be the same or different.

FIG. 5 illustrates an enter boundary 510t and an exit boundary 520t associated with one of the regions (i.e., region 320t) of FIG. 3. In this example, an enter boundary 310t corresponds to the bounds of region 320t and exit boundary 520t is located outside of the region 320t. An enter boundary and/or exit boundary may be within, on, or outside of the region to which they respectively correspond.

In some implementations, each of multiple points (e.g., points 310a-kk of FIG. 3) of a display is associated with multiple regions, e.g., each display region may be associated with an enter region (e.g., within a respective enter boundary), an exit region (e.g., within a respective exit boundary), and a high-resolution/foveation area region. The use of different enter regions/boundaries and exit regions/boundaries may provide various benefits. The use of different enter and exit regions for a given point/display region may serve to introduce some hysteresis when the user’s gaze moves between display regions, further obscuring gaze by preventing the recipient from identifying precise gaze direction based on being able to recognize a circumstance in which a user’s gaze is entering one display region and entering another display region and therefor at the precise location of a boundary between those adjacent regions.

Some implementations provide a temporal delay in providing gaze data when a user’s gaze enters and/or exits regions to obscure gaze information, e.g., obscuring the occurrence of small saccades. Such delays may be dependent on magnitude of eye movement (e.g., providing gaze updates in some circumstances such as when there are large eye movements but delayed gaze updates in other circumstances such as when there are relatively smaller eye movements).

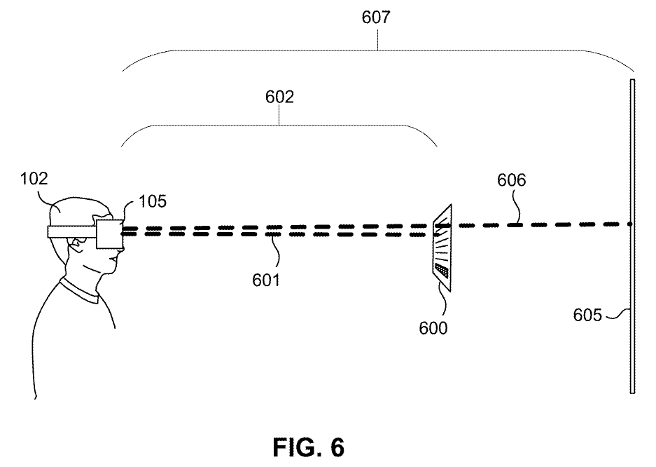

FIG. 6 illustrates use of depth information in providing generalized user gaze information. Some implementations use and/or provide depth information to supplement information about a user’s general gaze direction. Such depth information may be determined based on an understanding of the 3D environment that the user is viewing. In the case of XR, this may involve understanding the 3D positions of objects in a 3D coordinate system corresponding to a physical environment that are depicted and/or the 3D positions of virtual objects that are depicted within that 3D coordinate system.

In FIG. 6, for example, when the user’s gaze 601 is directed to a virtual content item 600, the distance 602 is determined. This distance 602 may be provided to an application along with information about the user’s general gaze direction (down-sampled information about gaze 601). Additionally, or alternatively, the distance 602 may be used to determine generalized gaze information that is provided to the application. When the user’s gaze 606 is directed to a depiction 615 of a wall 115 of the physical environment 100 (FIG. 1), the distance 607 is determined. This distance 607 may be provided to an application along with information about the user’s general gaze direction (down-sampled information about gaze 607). Additionally, or alternatively, the distance 607 may be used to determine generalized gaze information that is provided to the application.

The combination of gaze direction information with depth information may facilitate provision and/or use of the gaze information by an application or associated processes. For example, generalized gaze direction information and approximate depth information may be used to identify a portion of the 3D environment at which the user is gazing without revealing (or enabling determination of) specifically what the user is gazing at by an application. A single representative gaze direction towards such portion of the 3D environment may be determined thereby. Such information may be used to provide foveated rendering. Moreover, approximate depth information enables a single gaze direction to be used to identify where the user is generally looking without needed to provide (or even determine) converging gaze directions. There may be no need to use or provide binocular gaze information. Some implementations provide monocular-based gaze direction information without providing binocular-based gaze direction information, further protecting information from which user eye conditions, e.g., lazy eye, eye divergence conditions, etc., might be inferred.

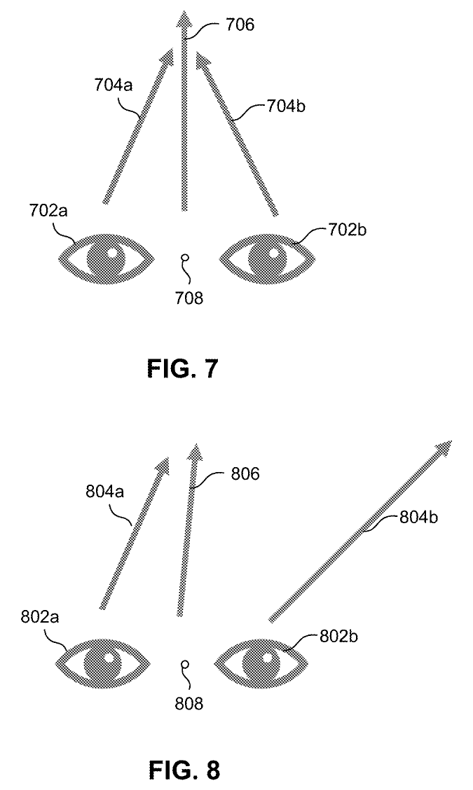

FIGS. 7 and 8 illustrate ways in which user gaze information may be simplified or configured as a single gaze direction that avoid revealing information about a user’s binocular gaze.

FIG. 7 illustrates use of a single representative gaze direction based on a binocular gaze assessment. In this example, a gaze direction 704a of left eye 702a is determined, a gaze direction704b of right eye 702b is determined, and a single representative gaze direction 706 from viewpoint 708 is determined based on these gaze directions 704a, 704b. The single representative gaze direction 706 may then be down-sampled or otherwise obscured, for example, via the techniques illustrated in, and described with respect to, FIGS. 3-5. The viewpoint 708 may be different then the positions of left eye 702a or right eye 702b, e.g., the viewpoint 708 may be a center point of the positions of left eye 702a or right eye 702b, to further obscure information about the user’s eyes. In some implementations, an operating system determines a single representative gaze direction in this way and provides only this information (i.e., only the single representative gaze direction) to the application or processes used thereby to facilitate foveated rendering or other gaze-based processes. In some implementations, both a single representative gaze direction (e.g., down-sampled or otherwise obscured) and a depth (e.g., approximate or otherwise obscured) are provided to the application or processes used thereby to facilitate foveated rendering or other gaze-based processes.

FIG. 8 illustrates use of a single direction based on a monocular gaze assessment to represent a gaze. In this example, gaze direction 804b of right eye 802b is not used. In this example, a gaze direction 804a of left eye 802a is determined, a depth of the content at which the user is looking is determined, and a single representative gaze direction 806 from viewpoint 808 is determined based on the gaze directions 804a and the depth (e.g., an approximate depth). The single representative gaze direction 806 may then be down-sampled or otherwise obscured, for example, via the techniques illustrated in and described with respect to FIGS. 3-5. The viewpoint 808 may be different then the positions of left eye 802a or right eye 802b, e.g., the viewpoint 808 may be a center point of the positions of left eye 802a or right eye 802b, to further obscure information about the user’s eyes. In some implementations, an operating system (OS) determines a single representative gaze direction in this way and provides only this information (i.e., only the single representative gaze direction) to the application or processes used thereby to facilitate foveated rendering or other gaze-based processes. In some implementations, both a single representative gaze direction (e.g., down-sampled or otherwise obscured) and a depth (e.g., approximate or otherwise obscured) are provided to the application or processes used thereby to facilitate foveated rendering or other gaze-based processes.

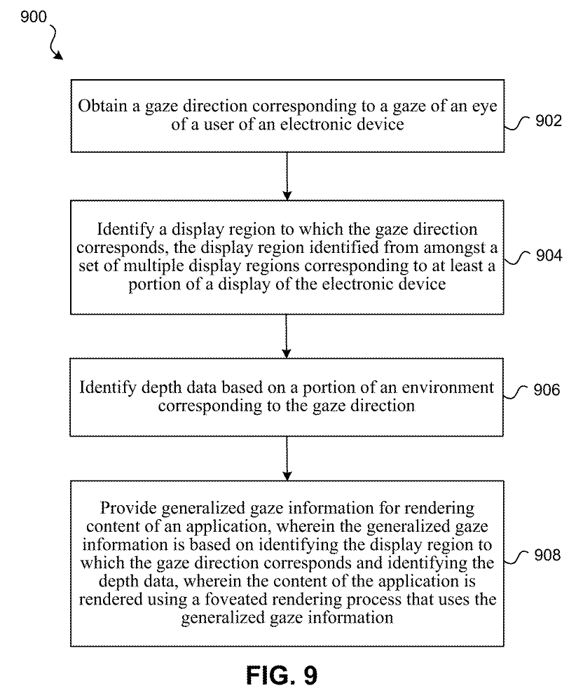

FIG. 9 is a flowchart illustrating a method 900 for enabling application use of gaze information by providing generalized gaze information. In some implementations, a device such as electronic device 105 or electronic device 110 performs method 900. In some implementations, method 900 is performed on a mobile device, desktop, laptop, HMD, or server device. The method 900 is performed by processing logic, including hardware, firmware, software, or a combination thereof. In some implementations, the method 900 is performed on a processor executing code stored in a non-transitory computer-readable medium (e.g., a memory).

At block 902, the method 900 involves obtaining a gaze direction corresponding to a gaze of an eye of a user of the electronic device. Gaze direction may be obtained via any existing or otherwise appropriate technique. For example, gaze tracking may be based on projecting a plurality of glints onto the eye, obtaining images or other sensor data of the eye, and interpreting the images or other sensor data to determine the eye’s position and/or orientation. As another example, images of a user’s eye or one or more portions thereof (cornea, pupil, retina, etc.) are captured and interpreted to track the eye’s position and/or orientation.

At block 904, the method 900 involves identifying a display region (e.g., a point corresponding to the region of interest) to which the gaze direction corresponds, the display region identified from amongst a set of multiple display regions (e.g., a grid of display regions) corresponding to at least a portion of a display of the electronic device. Each display region may be associated with a point (e.g., a center point) within the respective display region that may be used to provide gaze information instead of using the actual gaze direction. Each display region may be associated with enter and exit boundaries (e.g., as illustrated in FIG. 5) that differ from one another to further obscure gaze information such that gaze info is provided based on enter and exit events associated with those boundaries.

At block 906, the method 900 involves identifying depth data (e.g., an approximate depth) based on a portion of an environment corresponding to the gaze direction. The method 900 may involve determining that the user is gazing at a portion of a display of a head-mounted device (HMD) and that the content displayed at that portion of the screen corresponds to a portion of a 3D XR environment that is (or that the user perceives as being) a distance away from the user, i.e., the depth of the content.

The depth data may comprise or be used to determine information amount an approximate depth of content depicted on the display of the electronic device. In some implementations, the approximate depth is obtained by: rounding an actual depth of content at which the user is gazing; or averaging a plurality of depths within the display region. In some implementations, the approximate depth is determined by: determining that the user is gazing at a portion of the display; determining that content at that portion of the screen corresponds to a portion of a 3D extended reality (XR) environment associated with a distance away from a viewpoint of the user within the 3D XR environment; and determining the approximate depth by rounding the distance.

At block 908, the method 900 involves providing generalized gaze information for rendering content of an application, wherein the generalized gaze information is based on identifying the display region to which the gaze direction corresponds and identifying the depth data, wherein the content of the application is rendered using a foveated rendering process that uses

the generalized gaze information.

The generalized gaze information may identify that the gaze corresponds to the display region by identifying: the display region; a point at a center of the display region; or a direction from the user to the point at the center of the display region, as examples. The generalized gaze information may identify that the gaze corresponds to the display region without identifying the gaze direction. The foveated rendering process may have access to only the generalized gaze information and thus may be unable to access the gaze direction.

The generalized gaze information is based on gaze direction information from only a single eye of the user. The foveated rendering process may be unable to access information from which binocular gaze information can be determined.

The set of multiple display regions comprises a grid of display regions occupying the at least a portion of the display. Each of the set of multiple display regions may be associated with an enter boundary and a different exit boundary. Detection of the user gaze entering an enter boundary of a respective display region may trigger provision of additional generalized gaze information indicating that the gaze corresponds to the respective display region. Detection of the user gaze existing an exit boundary of the respective display region may trigger provision of additional generalized gaze information indicating that the gaze no longer corresponds to the respective display region.

In the method 900, the content of the application is rendered at and displayed by the electronic device. In the method 900, the content of the application may be rendered at a second electronic device separate from the electronic device and transmitted to the electronic device for display by the electronic device.

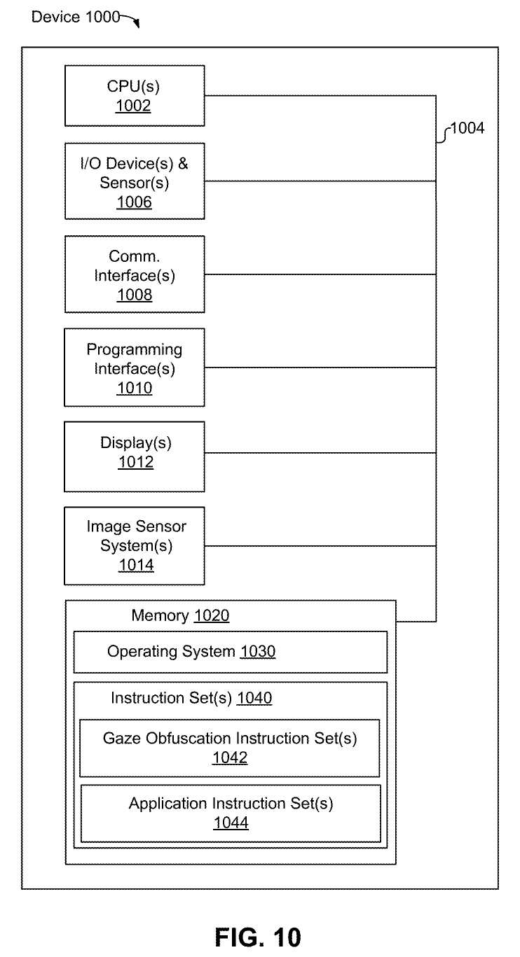

FIG. 10 is a block diagram of electronic device 1000. Device 1000 illustrates an exemplary device configuration for electronic device 110 or electronic device 105. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1000 includes one or more processing units 1002 (e.g., microprocessors, ASICs, FPGAs, GPUs, CPUs, processing cores, and/or the like), one or more input/output (I/O) devices and sensors 1006, one or more communication interfaces 1008 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1010, one or more output device(s) 1012, one or more interior and/or exterior facing image sensor systems 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1012 include one or more displays configured to present a view of a 3D environment to the user. In some implementations, the one or more displays 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1000 includes a single display. In another example, the device 1000 includes a display for each eye of the user.

In some implementations, the one or more output device(s) 1012 include one or more audio producing devices. In some implementations, the one or more output device(s) 1012 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener’s brain into interpreting sounds as if the sounds occurred at the point(s) in the 3D environment (e.g., from one or more particular sound sources) even though the actual sounds may be produced by speakers in other locations. The one or more output device(s) 1012 may additionally or alternatively be configured to generate haptics.

In some implementations, the one or more image sensor systems 1014 are configured to obtain image data that corresponds to at least a portion of a physical environment. For example, the one or more image sensor systems 1014 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1014 further include illumination sources that emit light, such as a flash. In various implementations, the one or more image sensor systems 1014 further include an on-camera image signal processor (ISP) configured to execute a plurality of processing operations on the image data.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 comprises a non-transitory computer readable storage medium.

In some implementations, the memory 1020 or the non-transitory computer readable storage medium of the memory 1020 stores an optional operating system 1030 and one or more instruction set(s) 1040. The operating system 1030 includes procedures for handling various basic system services and for performing hardware dependent tasks. In some implementations, the instruction set(s) 1040 include executable software defined by binary information stored in the form of electrical charge. In some implementations, the instruction set(s) 1040 are software that is executable by the one or more processing units 1002 to carry out one or more of the techniques described herein.

The instruction set(s) 1040 include gaze obfuscation instruction set(s) 1042 configured to, upon execution, obscure user gaze information provided to one or more applications, as described herein. The instruction set(s) 1040 include application instruction set(s) 1044 for one or more applications. In some implementations, each of the applications is provided for as a separately-executing set of code, e.g., capable of being executed via an application process. The instruction set(s) 1040 may be embodied as a single software executable or multiple software executables.

Although the instruction set(s) 1040 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user’s experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at an electronic device:
obtaining a gaze direction corresponding to a gaze of an eye of a user of the electronic device;
identifying a display region to which the gaze direction corresponds, the display region identified from amongst a set of multiple display regions corresponding to at least a portion of a display of the electronic device;
identifying depth data based on a portion of an environment corresponding to the gaze direction; and
providing generalized gaze information for rendering content of an application, wherein the generalized gaze information is based on identifying the display region to which the gaze direction corresponds and identifying the depth data, wherein the content of the application is rendered using a foveated rendering process that uses the generalized gaze information.

2. The method of claim 1, wherein the generalized gaze information identifies that the gaze corresponds to the display region by identifying:
the display region;
a point at a center of the display region; or
a direction from the user to the point at the center of the display region.

3. The method of claim 1, wherein the generalized gaze information identifies that the gaze corresponds to the display region without identifying the gaze direction.

4. The method of claim 1, wherein the foveated rendering process is unable to access the gaze direction.

5. The method of claim 1, wherein the generalized gaze information is based on gaze direction information from only a single eye of the user.

6. The method of claim 1, wherein the foveated rendering process is unable to access information from which binocular gaze information can be determined.

7. The method of claim 1, wherein the set of multiple display regions comprises a grid of display regions occupying the at least a portion of the display.

8. The method of claim 1, wherein each of the set of multiple display regions is associated with an enter boundary and a different exit boundary, wherein:
detection of the user gaze entering an enter boundary of a respective display region triggers provision of additional generalized gaze information indicating that the gaze corresponds to the respective display region; and
detection of the user gaze existing an exit boundary of the respective display region triggers provision of additional generalized gaze information indicating that the gaze no longer corresponds to the respective display region.

9. The method of claim 1, wherein an approximate depth of content at which the user is gazing is identified based on the gaze direction and the depth data.

10. The method of claim 9, wherein the approximate depth is obtained by:
rounding an actual depth of the content at which the user is gazing; or
averaging a plurality of depths within the display region.

11. The method of claim 9, wherein the approximate depth is determined by:
determining that the user is gazing at a portion of the display;
determining that content at that portion of the screen corresponds to a portion of a 3D extended reality (XR) environment associated with a distance away from a viewpoint of the user within the 3D XR environment; and
determining the approximate depth by rounding the distance.

12. The method of claim 1, wherein the content of the application is rendered at the electronic device.

13. The method of claim 1, wherein the content of the application is rendered at a second electronic device separate from the electronic device and transmitted to the electronic device for display.

14. The method of claim 1, wherein the electronic device is a head-mounted device (HMD).

15. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
obtaining a gaze direction corresponding to a gaze of an eye of a user of the electronic device;
identifying a display region to which the gaze direction corresponds, the display region identified from amongst a set of multiple display regions corresponding to at least a portion of a display of the electronic device;
identifying depth data based on a portion of an environment corresponding to the gaze direction; and
providing generalized gaze information for rendering content of an application, wherein the generalized gaze information is based on identifying the display region to which the gaze direction corresponds and identifying the depth data, wherein the content of the application is rendered using a foveated rendering process that uses the generalized gaze information.

16. The system of claim 15, wherein the generalized gaze information identifies that the gaze corresponds to the display region by identifying:
the display region;
a point at a center of the display region; or
a direction from the user to the point at the center of the display region.

17. The system of claim 15, wherein the generalized gaze information identifies that the gaze corresponds to the display region without identifying the gaze direction.

18. The system of claim 15, wherein the foveated rendering process is unable to access the gaze direction.

19. The system of claim 15, wherein the generalized gaze information is based on gaze direction information from only a single eye of the user.

20. A non-transitory computer-readable storage medium storing program instructions executable via one or more processors to perform operations comprising:
obtaining a gaze direction corresponding to a gaze of an eye of a user of the electronic device;
identifying a display region to which the gaze direction corresponds, the display region identified from amongst a set of multiple display regions corresponding to at least a portion of a display of the electronic device;
identifying depth data based on a portion of an environment corresponding to the gaze direction; and
providing generalized gaze information for rendering content of an application, wherein the generalized gaze information is based on identifying the display region to which the gaze direction corresponds and identifying the depth data, wherein the content of the application is rendered using a foveated rendering process that uses the generalized gaze information.
